(19) United States
(12) Patent Application Publication
(10) Pub. No.: US 2009/0075778 A1
(43) Pub. Date: Mar. 19, 2009

(54) Connection of a planetary gear drive with the spur gear and/or central gear in an automatic transmission

(75) Inventors: Thomas Merath, Tettnang (DE); Mathias Cuijpers, Tettnang (DE); Peter Tiesler, Meckenbeuren (DE)

Correspondence Address: DAVIS & BUJOLD, P.L.L.C., 112 PLEASANT STREET, CONCORD, NH, 03301, US

(73) Assignee: ZF Friedrichshafen AB, Friedrichshafen (DE)

(21) Appl. No.: 12/284,113

(22) Filed: Sep. 18, 2008

(30) Foreign Application Priority Data
Sep. 19, 2007 (DE) 102007044782.7

(51) Int. Cl. F16H 57/08

(52) U.S. Cl. 475/343

(57) ABSTRACT

A connection of a planetary gear drive with a spur gear in an automatic transmission is designed in such a manner that an axial force of the spur gear is counteracted by the axial force from the planetary gear drive, so that an axial equilibrium of forces can be achieved.

This application claims priority from German Application Serial No. 10 2007 044 782.7 filed Sep. 19, 2007.

### FIELD OF THE INVENTION

The invention concerns the connection of a planetary gear drive with the spur gear and/or central gear in an automatic transmission.

### BACKGROUND OF THE INVENTION

The Applicant's DE 103 33 437 A1 discloses a multi-speed automatic transmission, comprising an input shaft, an output shaft, three single planetary gearsets arranged side by side in a row, as well as five shifting elements. In the known transmission, a sun gear of the third gearset can be fixed on a transmission via the first shifting element. The drive shaft is furthermore connected to a sun gear of the second gearset and can be connected via the second shifting element to a sun gear of the first gearset and/or via the fifth shifting element to a carrier of the first gearset. As an alternative to this arrangement, the sun gear of the first gearset can be fixed on the transmission housing via the third shifting element and/or the carrier of the first gearset can be fixed on the transmission housing via the fourth shifting element. It is also provided to connect the input shaft to a ring gear of the first gearset and one of the carriers of the second or third gearset, wherein the second and fifth shifting element form an assembly, each having one disc set and one servo device, as well as one disc carrier for both shifting elements, wherein the disc set of the second shifting element has a larger diameter than the disc set of the fifth shifting element.

From DE 10 2004 050 123 A1 a power shift transmission is known with three planetary gearsets, which is selectively controlled via five torque transmission mechanisms to establish six forward speed ratios and one reverse speed ratio for the transmission. The torque transmission mechanisms comprise piston mechanisms, which can be displaceably arranged in elements of the transmission housing, which comprise a front-end cover, a rear-end cover and a shell that connects the front-end cover and the rear-end cover. The output of the planetary gear drive is also carried out via a carrier of the planetary gearset in the transmission according to DE 10 2004 050 123 A1.

It is further known that the output of the planetary gear drive can be carried out via a ring gear, wherein the ring gear is axially fixed on the spur gear via an intermediate ring.

It is an object of the invention to provide a connection of a planetary gear drive with a spur gear in an automatic transmission, such that the engagement of the intermediate gear ratio is optimized and a reduction in weight of the bearing plate can be achieved. A material conversion of the bearing plate to cast iron should in particular be made possible.

The stress to the housing caused by the number of bolts should also be reduced. It is another object of the invention to reduce the production and assembly costs and to improve the noise behavior, as well as the load capacity of the gearing and bearing.

### SUMMARY OF THE INVENTION

Accordingly, in order to improve the engagement and reduce the stress on the components, it is proposed to realize an internal equilibrium of the axial forces. This is achieved by counteracting the axial force of the central spur gear with the axial force from the planetary gear drive.

An equilibrium of forces in an axial direction is at least approximately realized by adjusting the directions and size of the helix angle. According to the invention, the axial force input from the planetary gear drive and the output of the planetary gear drive can be carried out by way of the ring gear, sun gear, sun gear shaft, planetary carrier or carrier shaft, while the spur gear should preferably be axially braced in both load directions. The equilibrium of forces takes place in traction as well as in coasting mode.

The element of the planetary gear drive, which is connected to the spur gear, can be axially secured or braced by way of two locking rings, one locking ring and one bearing area, other non-positive or positive locking elements or a concealed snap-in locking element. The bearing area can be designed herein as an axial contact surface or as an axial bearing area. The support can preferably be carried out via contact areas combined with locking elements.

A locking ring which accommodates axial loads in two directions can be used within the scope of a preferred further development of the invention.

According to the invention, the diameter of the axial force transmission is preferably within a comparable order of magnitude, such as the diameter of the gearing of the spur gear.

A connection of a planetary gear drive with the spur gear in an automatic transmission is made available by way of the design, by way of which the stress on the surrounding components, such as the bearing plate, bearing and screw connection is kept to a minimum. The inclination and deflection of all the parts is additionally reduced. The tilting between the running gears is particularly minimized. The necessary axial installation space as well as the weight, are preferably reduced.

### BRIEF DESCRIPTION OF THE DRAWINGS

The invention will now be described, by way of example, with reference to the accompanying drawings in which:

FIG. 1 shows a sectional view of the connection of a planetary gear drive with the spur gear according to the prior art;

FIG. 2 shows a sectional view of an embodiment of the connection of a planetary gear drive with the spur gear according to the invention;

FIG. 3 shows a sectional view of another embodiment of the connection a planetary gear drive with the spur gear according to the invention;

FIG. 4 shows a sectional view of a third embodiment of the connection of a planetary gear drive with the spur gear according to the invention;

FIG. 5 shows a sectional view of another embodiment of the connection of a planetary gear drive with the spur gear according to the invention, and

FIG. 6 shows a sectional view of another embodiment of the connection of a planetary gear drive with the spur gear according to the invention.

### DETAILED DESCRIPTION OF THE INVENTION

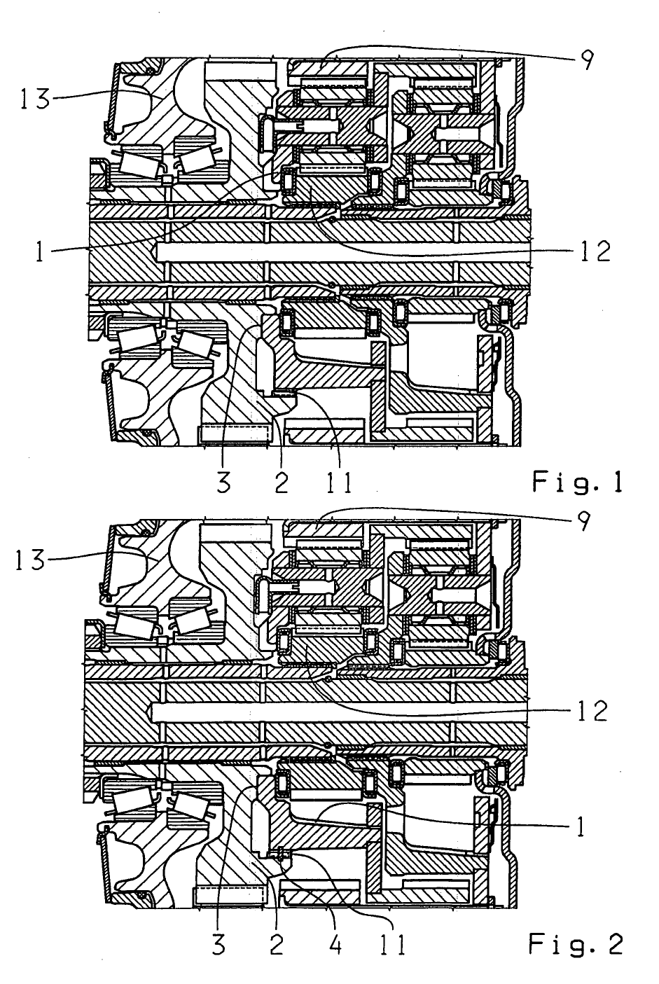

FIG. 1 shows part of a transmission according to the Applicant's DE 103 33 437 A1. The output of the planetary gear drive takes place herein via a carrier 1 of a planetary gearset. The carrier 1 is connected via a gearing 11 with a spur gear 2 to transmit the torque. As can be seen in FIG. 1, the gearset is axially braced via a bearing area 3. In the Figure, a ring gear of the planetary gearset is identified with reference numeral 9, a sun gear is identified with reference numeral 12 and a bearing plate of the spur and/or central gear 2 is identified with reference numeral 13.

In the exemplary embodiment shown in FIG. 2, the output also takes place via the carrier 1, while the carrier 1 is axially braced via the bearing area 3 and a locking ring 4. The connection of the carrier 1 with the spur gear 2 is designed in such a manner that the axial force of the spur gear 2 is counteracted by the axial force from the planetary gear drive. In FIG. 2, as well as the following Figures, the gearing between the carrier 1 and the spur gear 2 or between an element of the planetary gear drive with the spur gear 2 is identified with reference numeral 11. The equilibrium of force is realized by way of corresponding directions and size of the angle of inclination.

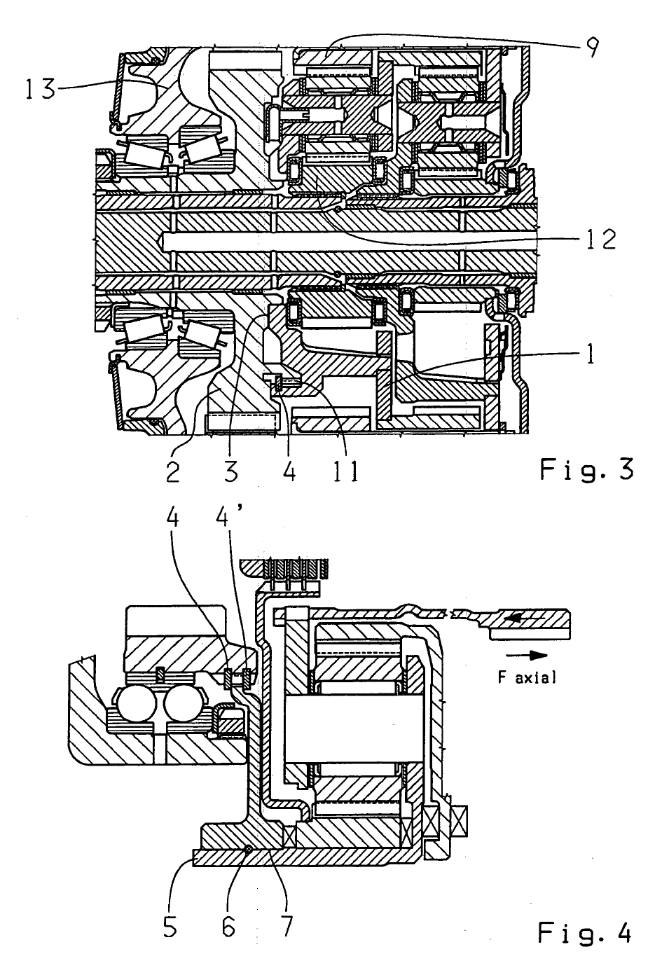

The diameter of the axial force transmission can be within a comparable order of magnitude, such as the diameter of the gearing of the spur gear 2, as shown in FIG. 3. The carrier 1 on the spur gear 2 is axially braced by way of the locking ring 4 and the axial bearing area 3 in the example shown.

The element of the planetary gear drive or the planetary gear drive connected to the spur gear 2 can also be axially braced by way of two locking rings 4, 4′, as shown in FIG. 4. In the embodiment shown, the output takes place by way of a carrier shaft 5, while the output carrier is axially locked via a locking ring 6 and an axial contact area 7. In the latter as well as in the subsequent Figures, the axial forces are identified with reference character F and indicated with the corresponding arrows for each direction.

The output carrier can also be axially secured by way of the locking ring 6 and the axial contact area 7, as shown in FIG. 5. The locking ring 6 is arranged in such a way that it can absorb axial loads in two directions.

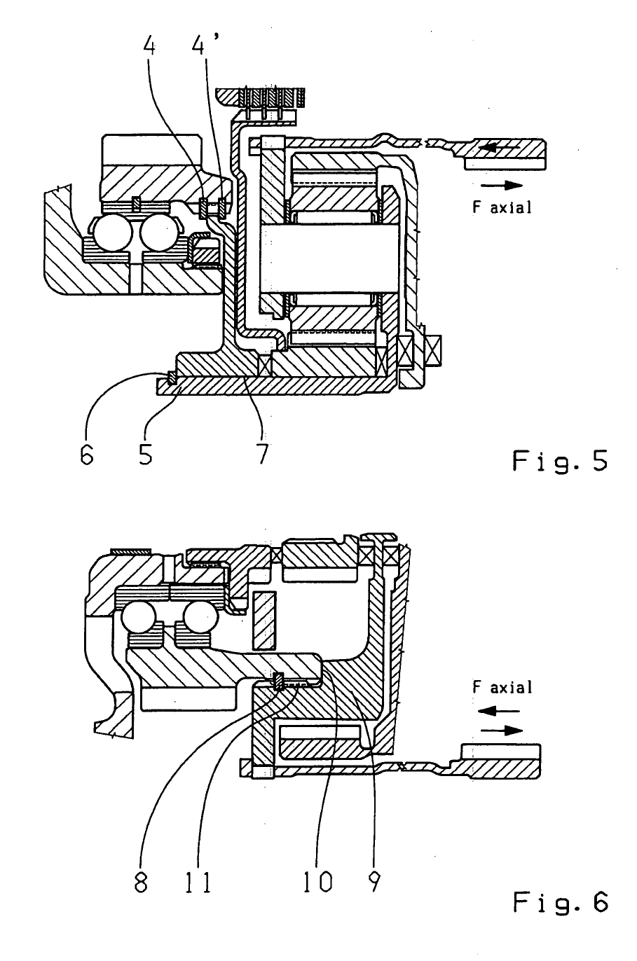

The object of FIG. 6 is an embodiment in which the output takes place by way of the ring gear 9 of a planetary gearset and the bearing takes place by way of a locking ring 8 as well as an axial bearing area 10.

### REFERENCE NUMERALS

1 carrier
2 spur gear
3 bearing area
4, 4′ locking ring
5 carrier shaft
6 locking ring
7 contact area
8 locking ring
9 ring gear
10 contact area
11 gearing
12 sun gear
13 bearing plate
F axial forces

1-10. (canceled)

11. A connection of a planetary gear drive with a spur gear (2) in an automatic transmission, the connection being designed such that an axial force of the spur gear (2) is counteracted by an axial force of the planetary gear drive.

12. The connection of the planetary gear drive with the spur gear in the automatic transmission according to claim 11, wherein directions and size of a helix angle equilibrate forces in an axial direction.

13. The connection of the planetary gear drive with the spur gear in the automatic transmission according to claim 11, wherein an axial force input takes place from the planetary gear drive and an output takes place by way of one of a ring gear (9), a sun gear (12), a sun gear shaft, a planetary carrier (1) and a carrier shaft (5), and the spur gear (2) is axially braced in both load directions.

14. The connection of the planetary gear drive with the spur gear in the automatic transmission according to claim 13, wherein a diameter of the axial force transmission is within a comparable order of magnitude as a diameter of gearing of the spur gear (2).

15. The connection of the planetary gear drive with the spur gear in the automatic transmission according to claim 13, wherein the one of the ring gear (9), the sun gear (12), the sun gear shaft, the planetary carrier (1), the carrier shaft (5), the spur gear (2) and the planetary gear drive that is connected to the spur gear is axially braced by one of a concealed snap-in locking element, two locking rings (4, 4′), and a locking ring (4) and a bearing area (3).

16. The connection of the planetary gear drive with the spur gear in the automatic transmission according to claim 15, wherein the bearing area is one of an axial contact area (7) and an axial bearing area (10).

17. The connection of the planetary gear drive with the spur gear in the automatic transmission according to claim 13, wherein the output of the planetary gear drive takes place via the carrier (1), and the carrier (1) is axially braced via an axial bearing area (3) and a locking ring (4).

18. The connection of the planetary gear drive with the spur gear in the automatic transmission according to claim 13, wherein the output of the planetary gear drive takes place via the carrier shaft (5), and the carrier is axially secured via a locking ring (6) and axially braced via two locking rings (4, 4′).

19. The connection of the planetary gear drive with the spur gear in the automatic transmission according to claim 13, wherein the output of the planetary gear drive takes place via the carrier shaft (5), and an output strut is axially secured with a locking ring (6) and an axial contact area (7) and is braced by two locking rings (4, 4′).

20. The connection of the planetary gear drive with the spur gear in the automatic transmission according to claim 13, wherein the output of the planetary gear drive takes place via the ring gear (9) which braced by of a locking ring (8) and an axial bearing area (10).

21. A planetary gear drive of an automatic transmission comprising:
a planetary gearset having a sun gear (12), a ring gear (9) and a planetary gear carrier (1);
a spur gear (2) being coaxially aligned with the planetary gearset and communicating with the planetary gear carrier (1) for transferring torque therebetween, and the spur gear (2) transmitting an axial force, in a first axial direction, to the planetary gear carrier (1); and
the planetary gear carrier (1) is axially fixed by one of:
a bearing area (3) and a first locking ring (4),
the first locking ring (4) and a second locking ring (4′), and
an axial contact area (7) and the first locking ring (6), to provide an axial force in a second axial direction which offsets the axial force in the first axial direction.

22. The planetary gear drive according to claim 21, wherein drive is output from the planetary gearset through the planetary gear carrier (1), which is axially fixed by engaging the bearing area (3) and the first locking ring (4).

23. The planetary gear drive according to claim 22, wherein the planetary gearset has a diameter that is substantially equivalent to a diameter of the spur gear (2).

24. The planetary gear drive according to claim 21, wherein the planetary gear carrier (1) is fixed to a carrier shaft (5), which outputs drive from the planetary gearset, the carrier shaft (5) engages the axial contact area (7) and the first locking ring (6) and the spur gear (2) engages the first locking ring (4) and the second locking ring (4′) to axially fix the planetary gear carrier (1).
